(19) United States
(12) Patent Application Publication
(10) Pub. No.: US 2021/0039178 A1
(43) Pub. Date: Feb. 11, 2021

(54) A Wall Structure Cutting Wire Saw

(71) Applicant: 1Diamond AS, Gjøvik (NO)

(72) Inventor: Harald RAMFJORD, Gjøvik (NO)

(21) Appl. No.: 16/966,198

(22) PCT Filed: Jan. 30, 2019
(86) PCT No.: PCT/NO2019/050026

§ 371 Date: Jul. 30, 2020

(30) Foreign Application Priority Data
Jan. 30, 2018 (NO) 20180147

(51) Int. Cl. B23D 57/00; B28D 1/08

(52) U.S. Cl. CPC B23D 57/0084; B23D 57/0061; E02B 17/00; B28D 1/088; B23D 57/0007

(57) ABSTRACT

The present invention relates to a wall structure cutting wire saw. The wire saw includes a master saw unit 12 with master rail elements 35 adapted to run on a first set of tracks 7. The master saw unit 12 includes a wire drive motor 18, a wire magazine 17 accommodating a portion of a of cutting wire 15 in a cutting wire loop, and a saw drive 11 adapted to drive the master saw unit 12 along the first set of tracks 7. The master saw unit also includes a wire tension actuator. A slave unit 13 with at least one slave wire return wheel 23 and slave rail elements 36 is adapted to run on a second set of rails 8. The invention further includes a first set of rails adapted to be secured to a first side of the wall structure; and a second set of rails adapted to be secured to a second side of the wall structure 33. The wall structure 33 may form a wall of a GBS leg.

The present invention concerns a wall structure cutting wire saw. Particularly, the invention relates to a saw for cutting inclined cuts through legs on GBS platforms.

When offshore oilfields are depleted or offshore platforms of some reason are taken out of service, the companies running the installations are obliged to remove or maintain at least parts of the installation. Such decommissioning and removal poses several challenges. One challenge is removal of the topside on GBS offshore installations. Many installations include a topside with a Main Support Frame or MSF fixed to the gravity based structures (GBS) legs. In many cases, these legs must be cut before the MSF can be lifted. Legs of this kind are often made of steel reinforced concrete.

Cutting of GBS legs is proposed in GB2458053 (B), (same applicant). This publication proposes providing a wire saw with a first frame surrounding the leg and moving a second frame with a sawing wire loop in relation to the first frame and cut the leg. The saw spans the entire diameter of the leg. The cut is horizontal and a cut surface is plane. The leg, formed with a wall structure, does not form a part of the saw.

With the above solution, the cut transition between the upper part and the lower part remains plane, and there is a risk that the upper part/topside move in a horizontal plane under the influence of wind, large waves, due to motion in the structure etc. Furthermore, the magnitude of the span of the saw, may reduce the accuracy of the cut, and an inaccurate cut can make the situation difficult. An accurate cut is also important to avoid any issues with inadvertently cutting into reinforcing steel inside the concrete. Cutting into stressed steel reinforcements extending downwards from the cut that may jeopardize the integrity of the leg with possible leg failure and fatal consequences.

A cutting process is time consuming, and it is important that the GBS maintains its integrity, only resting on its legs, even after the legs are cut. In some cases, the GBS must remain complete, with its legs cut off for extended periods of time, for instance while waiting for a weather window with a sufficiently calm weather to allow a topside to be lifted off the cut legs.

Accordingly there is a need for a gravity based structure with legs that for a time period after the legs are cut and before the topside is lifted off, maintains its structural integrity to satisfy safety requirements and to prevent a catastrophe. It is a purpose with the present invention to provide a solution that will enable a GBS to resist a 100 year wave in the above explained cut off state, only resting on its cut off legs due to gravity. Furthermore, it is a purpose to reduce the risk that the topside move sideways due to fluctuating forces from wind and waves. Microscopic movements of the legs may result in side forces acting on the cut interface, allowing the topside to gradually work it way sideways on the legs to the extent that an unpredictable situation may be the result.

The present invention solves this issue by providing a platform with legs that are cut off, still in a horizontal plane, but at an angle to allow the transition between to two cut part to form an obtuse cone. The upper and lower parts are formed simultaneously, and the cutting process will induce negligible motion in the cutting area.

Furthermore, the present invention provides a wire saw where the wall structure of the leg forms a part of a sawing system.

Cutting of such legs involve a certain risk, and it is an advantage if the cutting can be controlled from a remote location to reduce the risk for operating personnel.

In the following description are the words elliptical and ellipsis intended to cover circular, oval or any other shape of a cross section without sharp corners. The words elliptical and ellipsis is intended to describe shapes allowing a loop of rails to surround the cross section both internally and externally without being interrupted by sharp corners preventing a master saw unit and a slave unit running on the rails from performing a complete round around the cross section. In the most common situation, the ellipsis is a circle. The shape of the cross section depends on the structure to be cut. Such structures may include cooling towers, chimneys and silos.

Accordingly, the present invention relates to an elliptical wall structure cutting wire saw with a master saw unit with master rail runner elements adapted to run on a rail with a first set of rails forming an ellipse at a first side of the elliptical wall structure. The master saw unit includes a wire drive motor, a wire magazine accommodating a portion of a of cutting wire in a cutting wire loop, a saw drive adapted to drive the master saw unit along the first set of rails and a wire tension actuator. A slave unit with at least one slave return wheel and slave rail runner elements is adapted to run on a second set of rails forming an ellipse at a second side of the elliptical wall structure. A first set of rails forming an elliptic circular track is adapted to be secured in a horizontal plane to the first side of the wall structure, and a second set of rails, forming an elliptic track, is adapted to be secured in a plane to the second side of the wall structure. The GBS leg wall structure cutting wire saw is adapted to perform a complete cut around the GBS leg wall structure in one operation.

The slave return wheel may be located above two cutting gap guide wheels on the master saw unit in relation to a horizontal plane.

The wall structure cutting wire saw may further include a third set of rails adapted to be secured to the first side of the wall structure at a distance from and parallel to the first set of rails.

At least one of the sets of rails may include a gear rim or a pitch rack.

The slave unit may includes a slave drive motor for driving the slave unit along the second set of rails.

The slave drive motor may be battery powered, and the slave unit may include a battery pack.

The master saw unit and the slave unit may include communication means adapted to coordinate the speed of the master saw unit and the slave unit along their respective rails and to communicate sawing parameters between the wall structure cutting wire saw and a remote controller. The communication means may be wireless communication means.

The master saw unit and the slave unit include retaining elements holding the master saw unit and the slave unit to their respective rails.

The retaining elements holding the master saw unit and the slave unit to their respective rails may be formed by the master rail elements and the slave rail elements respectively.

The wall structure cutting wire saw may further include a wall structure, wherein the first set of rails is secured to the first side of the wall structure, and the master rail elements of the master saw unit may rest against the first set of rails. The second set of rails may be secured to the second side of the wall structure, and the slave rail elements of the slave unit may rest against the second set of rails. The cutting wire in the cutting wire loop extend through the reinforced concrete wall structure, between the master saw unit and the slave unit.

The first set of rails secured to the first side of the wall structure may form an inner ellipsis inside the GBS leg, and the second set of rails secured to the second side of the wall structure forms an outer ellipsis outside the GBS leg.

The circles formed by the tracks are located in a horizontal plane.

The sawing wire may be inclined and produce a cut in a range of 1-5° off a horizontal line.

The sawing wire may be inclined and produce a cut at an angle of 5° off a horizontal line.

The sawing wire may be inclined and produce a cut at an angle of 10° off a horizontal line.

The sawing wire may be inclined and produce a cut at an angle of 5°-10° off a horizontal line.

Short description of the enclosed drawings:

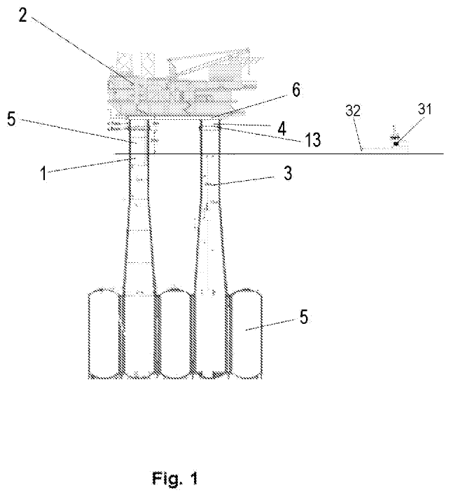

FIG. 1 shows an offshore platform for exploration of hydrocarbons;

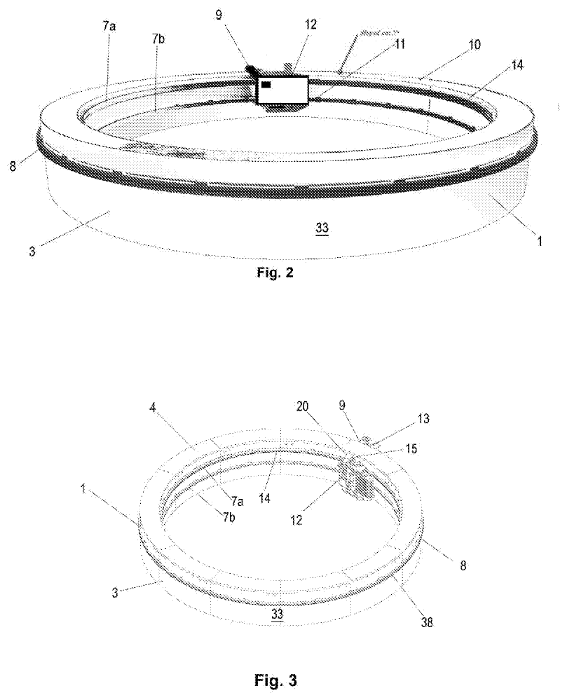

FIG. 2 is a perspective view of a part of a lower leg portion of a platform leg;

FIG. 3 is a perspective view of a portion of platform leg forming a wall structure with a saw of the invention;

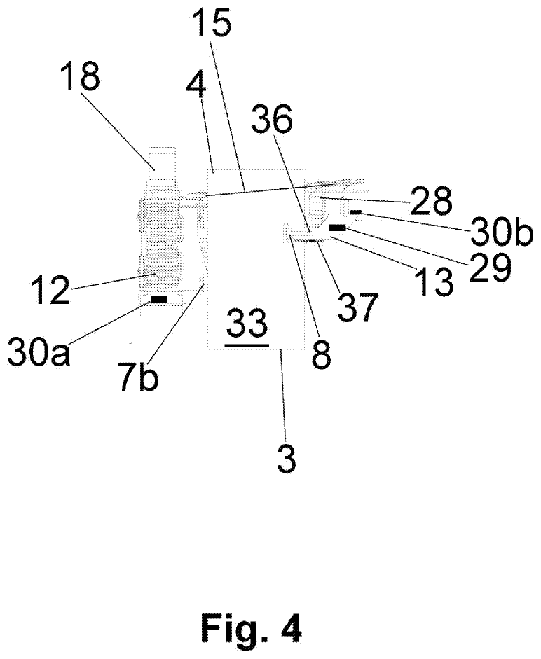

FIG. 4 is a side elevation of a saw of the invention on a wall structure;

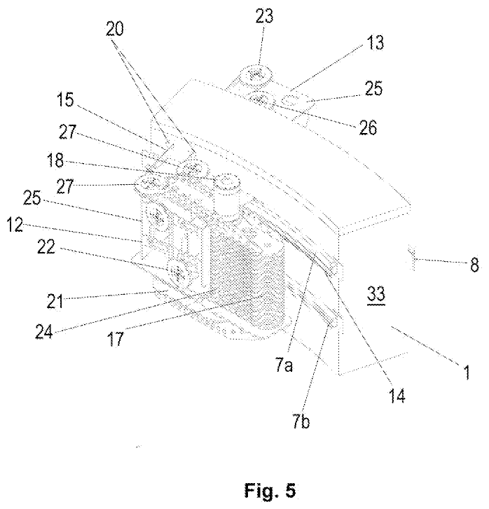

FIG. 5 is a perspective view of the saw shown on FIG. 4; and

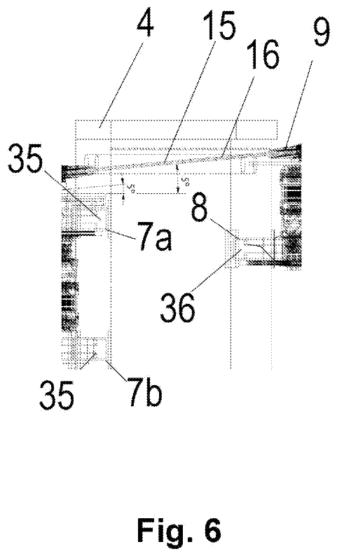

FIG. 6 shows the saw in greater detail to highlight the two master rail elements.

Detailed description of the enclosed drawings with reference to an embodiment of the invention:

FIG. 1 shows an offshore platform for exploration of hydrocarbons. The offshore platform is about to become decommissioned and the platform legs 1 legs are cut for removal of the topside 2. The offshore platform is a GBS, (Gravity Based Structure) and the legs 1 are steel reinforced concrete legs on a GBS caisson located on a seabed. The topside 2 sits on top of a girder deck structure/cellar deck 6 secured to the platform legs 1. The platform includes three platform legs 1. Each platform leg 1 includes a lower leg portion 3 extending from the GBS caisson and an upper leg portion 4 secured to the girder deck structure. The girder deck structure 6 forms a rigid foundation/base for the topside 2. A sloped cut 13 in the elliptical or circular cross-section of each leg forms a transition between the lower leg portion 3 and the upper leg portion 4. The upper leg portion 4 is very short compared to the lower leg portion as the upper leg portion is located above any internal steel reinforcements extending down into the leg that would compromise the leg integrity if cut. The sloped cut 13 in the circular cross-section of the leg forms a conical/frustoconical surface. The inclination of the sloped cut is 5°. The modest inclination allows the forces from the weight of the topside to be evenly distributed over the transitional area without inducing substantial additional stresses in the legs 1 after they are cut. Steeper inclination could result in unwanted hoop stresses in the legs 1. Steep inclination could also result in a wedging and sticking of the legs, resulting in difficulties when the topside is to be lifted off the legs. The sloped cut also ensures that the topside will be centred on the legs, even under substantial horizontal loads from winds, waves etc. The cut is performed above any steel reinforcements to prevent any unpredictable conditions and possible fatal collapse of a leg. A support vessel 32 with a remote controller 32 monitors and controls a cutting process, forming the sloped cut 13.

FIG. 2 is a perspective view of a part of a lower leg portion 3 of a platform leg 1. The platform leg 1 includes wall structure 33 that is cut. The lower leg sloped cut surface 10 is shown with a 5° inwards inclination. On FIG. 2, the topside and the upper leg portion is removed, while the master sawing unit 12 is in place for illustration purposes. In real life however, the saw would in most cases be removed before the topside and upper leg portion is lifted off the lower leg portion 3. The master saw unit 12 with a sawing portion 9 is movable along the upper inner saw rails 7a and the lower inner saw rails 7b. The master saw unit 12 is driven along the inner saw rails 7a, 7b with a saw drive 11. The sawing portion 9 is inclined 5° in relation to a horizontal plane. The inner sawing rails 7a, 7b are interlocking with retaining elements on the master saw unit 12 to hold the master saw unit 12 onto the rails 7a, 7b. A geared rim 14 runs along the upper inner saw rail 7a and is meshing with a gear on the saw drive 11 to provide propulsion for the master saw unit 12. The platform leg 1 is cut by providing at least one initial hole (not shown) through the wall structure 33 of the leg 1 of a sufficient size to allow the sawing portion 9 to extend through the wall. The sawing portion 9 is allowed to extend through the at least one hole. The master saw unit 12 and the saw drive 11 is then operated to move the master saw unit 12 with the sawing portion 9 along the inner saw rails 7a, 7b to saw through the wall structure 33 to cut through the leg 1 to perform the sloped cut. The saw is driven through 360° around the leg wall structure 33 to finish the cut.

The upper leg portion (not shown in FIG. 2) remains on top of the lower leg portion and remains stable due to the sloped cut.

The sawing portion 9 typically includes a flexible and longitudinal diamond element such as a diamond wire typically used for sawing purposes. A sawing portion including a blade is more difficult to use as the vertical load from the upper leg portion is considerable, and a blade will typically be jammed between the upper leg portion and the lower leg portion.

In this disclosure is the term “circular cross-section” intended to cover slightly elliptical cross-sections in a horizontal plane. It is however relevant that the cuts are performer in a horizontal plane to prevent any forces acting sideways.

FIG. 3 shows a portion of the platform leg 1 forming a wall structure 33, the upper leg portion 4 and the lower leg portion 5 with the master saw unit 12 installed, but before the leg 1 is cut. The topside 2, platform 5 etc. is removed for clarity. The outer saw rail 8 runs in a horizontal ellipsis around the outer perimeter of the platform leg along with an outer toothed rim 38. The slave unit 13 runs on the outer rails 8 and include at least one freewheeling wheel/pulley for a diamond belt or diamond wire 15 forming the sawing portion 9 attached to the master saw unit 12. The sawing portion 9 runs at an angle in the range 1°-5° off horizontal. The slave unit 13 is powered with an electric motor to drive the slave unit 13 along the outer rails, and the outer rails include the toothed rim 38 meshing with a motor operated gear on the slave unit 13. The diamond wire 15 runs through two holes 20 drilled through the wall structure 33 during installation. The master saw unit 12 runs on the upper, inner saw rail 7a and the lower inner saw rail 7b and is driven along these rails, utilising toothed rim 14. The wall structure 33 forms a portion of the total wire saw 25 after the saw is installed. Installation of the saw includes installation of the first set of rails/the upper inner set of rails 7a, the second set of rails/the outer rails 8, and the third set of rails/the lower inner rails 7b on the wall structure 33.

FIG. 4 shows a portion of a cut platform leg with the wall structure 33 with the lower leg portion 3 and the upper leg portion 4 divided/split forming a cut interface, shown with the same line as the line indicating the cutting wire 15. The master saw unit 12 drives the cutting wire 15 in a cutting wire loop extending through the platform leg wall structure 33. The slave unit 13 runs along the outer saw rail 8 and includes at least one wire wheel/sheave to return the cutting wire 15 back to the master saw unit 12. The inner and outer saw rails 7b, 8 are C-shaped and designed to hold the slave unit 13 and the master saw unit 12 respectively to the platform leg to prevent the slave unit 13 and the master saw unit 12 from falling down in the event of a cutting wire 15 failure. Master rail elements and slave rail elements 36 form rail runners running along the rails. The rail elements may be formed as a wheel/ball bearing running in a C-shaped rail to prevent the rail elements 36 from derailing or leave the rail. Alternatively, the rail elements 36 may be solid blocks of low friction material allowing the rail elements 36 to slide inside the tracks/rails. The sawing portion is formed between the slave unit 13 and the master saw unit 12. Two portions of the sawing wire loop runs through the cutting area. The cut interface is inclined 5° off a horizontal plane. A slave drive motor 28 drives a slave drive gear 37 along the gear rim/toothed rim running in parallel to the outer saw rail 8 to move the slave unit 13 along the outer circumference of the platform leg in coordination with the master saw unit 12 to cut the leg. The slave drive motor 28 is powered by a battery pack 29, and is controlled through communication means 30b, communicating with communication means 30a on the master saw unit 12. The communication means may also communicate with the remote controller on the support vessel. Communication may include transfer of data related to wire loop speed, wire loop tension at several locations, motor temperature, battery charging state, cutting speed, saw location in relation to the rails, current draw, etc. An electric wire drive motor 18 drives one or both of the magazine drums to 24 to rotate the wire loop formed by the sawing wire.

The cut is performed in a horizontal plane as gravity is used to hold the cut elements together and to avoid forces with a horizontal component.

FIG. 5 is a detail of FIG. 3 showing a portion of a platform leg 1 with the wire saw 25 of the invention. The wire saw 25 is divided into the master saw unit 12 and the slave unit 13 each running along respective inner saw rails 7a, 7b and outer saw rails 8. The master saw unit 12 and the slave unit 13 are joined by the cutting wire 15, extending through holes 20 in the platform leg wall. The cutting wire may alternatively be a cutting belt. FIG. 5 shows the saw installed, ready to commence sawing.

The master saw unit 12 includes a sawing wire magazine 17 with two sawing wire magazine drums 24, holding the sawing wire. The magazine drums include twenty loops/revolutions of wire to hold about 53 meters of wire. The sawing wire magazine 17 allows the sawing wire to contain a sufficient amount of diamonds or another cutting/abrasive material to be embedded in the cutting wire. The distance between the magazine drums 24 is controlled by a tension actuator 21 to control the tension in the cutting wire 15. The electric wire drive motor 18 drives one of the magazine drums to 24 to rotate the wire loop formed by the sawing wire. Four wire guide wheels 22, guides the sawing wire 15 between the cutting portion of the wire saw and the wire magazine 17. Free wheeling slave return wheel 23 on the slave unit 13 returns the cutting wire loop from the slave unit 13 and back to the master saw unit 12. Push wheel 26 ensures that the cutting wire not is pushed off slave return wheel 23 when the cutting wire 15 is exposed to forces in the direction of the cut and the saw rails. The slave return wheel 23 and the push wheel 26 are located above two cutting gap guide wheels 27 in relation to a horizontal plane, to perform the inclined cut. Any of the cutting gap guide wheels 27, the slave return wheel 23 and the slave push wheel 26 may be slightly inclined to rotate the cutting wire 15 around its own axis. The motion of the sawing mechanism 12 and the slave unit 13 is coordinated by the saw drive driving the master saw unit 12 along the inner saw rail 7 and the gear rim 14, and the corresponding drive mechanism on the slave unit 13 drives the slave unit along the outer saw rails 8 and an outer gear rim. The drive mechanism on the slave unit 13 is typically battery powered.

FIG. 6 shows the saw in greater detail to highlight the two master rail elements 36 and the slave rail elements 36 in the inner saw rails 7a, 7b and two outer saw rail 8 respectively. The 5° inclination of a horizontal line is also shown. The upper leg portion 4 is divided from the lower leg portion, forming the leg interface 16 along the line cut by sawing/cutting wire 15. The cutting gap guide wheels are inclined at the same angle as the cutting wire to ensure proper alignment with the cutting wire.

An example of a leg to be cut: a leg with an inner radius of 5405 mm and an outer radius of 6245 mm and a thickness of 840 mm, may require a sawing wire loop with a length of typically 50-55 m.

| | |
|---|---|
| 1 | Platform leg |
| 2 | Topsides |
| 3 | Lower leg portion |
| 4 | Upper leg portion |
| 5 | Platform |
| 6 | Plate girder deck structure/ |
| 7a | Inner/first saw tracks/rails, upper |
| 7b | Inner/first saw tracks/rails, lower |
| 8 | Outer/second saw tracks/rails |
| 9 | Sawing portion |
| 10 | Lower leg sloped cut surface |
| 11 | Saw drive |
| 12 | Master master saw unit |
| 13 | Slave unit |
| 14 | Inner gear rim |
| 15 | Cutting wire |
| 16 | Cut Interface |
| 17 | Wire magazine |
| 18 | Wire drive motor |
| 19 | Wire tension actuator |
| 20 | Drilled holes |
| 21 | Tension actuator |
| 22 | Guide wheels |
| 23 | Slave wire return wheel |
| 24 | Magazine drums |
| 25 | Wire saw |
| 26 | Slave push wheel |
| 27 | Cutting gap guide wheels |
| 28 | Slave drive motor |
| 29 | Battery pack |
| 30a | Communication means |
| 30b | Communication means |
| 31 | Remote controller |
| 32 | Support vessel |
| 33 | Wall structure |
| 35 | Master rail elements |
| 36 | Slave rail elements |
| 37 | Slave drive gear |
| 38 | Outer gear rim |

1. An elliptical wall structure cutting wire saw comprising:
a master saw unit (12) with master rail runner elements (35) adapted to run on a rail (7) with a first set of rails forming an ellipse at a first side of an elliptical wall structure, the master saw unit (12) comprising a wire drive motor (18), a wire magazine (17) accommodating a portion of a of cutting wire (15) in a cutting wire loop, a saw drive (11) adapted to drive the master saw unit (12) along the first set of rails (7);
a wire tension actuator (19);
a slave unit (13) with at least one slave return wheel (23) and slave rail runner elements (36) adapted to run on a second set of rails (8) forming an ellipse at a second side of the elliptical wall structure;
a first set of rails forming an elliptic circular track, adapted to be secured in a horizontal plane to the first side of the wall structure (33); and
a second set of rails, forming an elliptic track, adapted to be secured in a plane to the second side of the wall structure (33), whereby the wall structure cutting wire saw is adapted to perform a complete cut around a GBS leg wall structure in one operation.

2. The wall structure cutting wire saw of claim 1 wherein the slave return wheel (23) is located above two cutting gap guide wheels (27) on the master saw unit (12) in relation to a horizontal plane.

3. The wall structure cutting wire saw of claim 1, further comprising a third set of rails (7b), adapted to be secured to the first side of the wall structure (33), at a distance from and parallel to the first set of rails (7a).

4. The wall structure cutting wire saw of claim 1, wherein at least one of the sets of rails comprise a gear rim or a pitch rack (14).

5. The wall structure cutting wire saw of claim 1, wherein the slave unit (13) comprises a slave drive motor (28) for driving the slave unit along the second set of rails (8).

6. The wall structure cutting wire saw of claim 5, wherein the slave drive motor (28) is battery powered, and the slave unit (13) comprises a battery pack (29).

7. The wall structure cutting wire saw of claim 1, wherein the master saw unit (12) and the slave unit (13) comprise communication means (30a, 30b) adapted to coordinate the speed of the master saw unit (12) and the slave unit (13) along their respective rails and to communicate sawing parameters between the wall structure cutting wire saw and a remote controller (31).

8. The wall structure cutting wire saw of claim 1, wherein the master saw unit (12) and the slave unit (13) comprise retaining elements holding the master saw unit (12) and the slave unit (13) to their respective rails.

9. The wall structure cutting wire saw of claim 8, wherein retaining elements holding the master saw unit (12) and the slave unit (13) to their respective rails are formed by the master rail elements (35) and the slave rail elements (36) respectively.

10. The wall structure cutting wire saw of claim 1,
wherein the first set of rails (7) is secured to the first side of the wall structure (33), and master rail elements (35) of the master saw unit (12) rest against the first set of rails (7); the second set of rails is secured to the second side of the wall structure (33), and slave rail elements (36) of the slave unit (13) rest against the second set of rails (8);
wherein the cutting wire (15) in the cutting wire loop extend through the reinforced concrete wall structure (33), between the master saw unit (12) and the slave unit (13).

11. The wall structure cutting wire saw of claim 1, wherein the first set of rails secured to the first side of the wall structure (33) forms an inner ellipsis inside the GBS leg, and the second set of rails (8) secured to the second side of the wall structure (33) forms an outer ellipsis outside the GBS leg.

12. The wall structure cutting wire saw of claim 11, wherein the circles formed by the tracks are located in a horizontal plane.

13. The wall structure cutting wire saw of claim 11, wherein the sawing wire (15) is inclined and produce a cut in a range of 1-5° off a horizontal line.

14. The wall structure cutting wire saw of claim 11, wherein the sawing wire (15) is inclined and produce a cut at an angle of 5° off a horizontal line.

15. The wall structure cutting wire saw of claim 1, wherein the sawing wire (15) is inclined and produce a cut at an angle of 10° off a horizontal line.

16. The wall structure cutting wire saw of claim 1, wherein the sawing wire (15) is inclined and produce a cut at an angle of 5°-10° off a horizontal line.
